(19) United States
(12) Patent Application Publication
(10) Pub. No.: US 2022/0173414 A1
(43) Pub. Date: Jun. 2, 2022

(54) METHOD OF PRODUCING A SEPARATOR

(71) Applicants: NOK CORPORATION, Tokyo (JP); HONDA MOTOR CO., LTD., Tokyo (JP)

(72) Inventors: Daiki SHIGENARI, Shizuoka (JP); Akihito GIGA, Saitama (JP); Suguru OMORI, Saitama (JP)

(21) Appl. No.: 17/456,409

(22) Filed: Nov. 24, 2021

(30) Foreign Application Priority Data
Nov. 27, 2020 (JP) 2020-197239

(51) Int. Cl. H01M 8/0286; H01M 8/0273

(52) U.S. Cl. CPC H01M 8/0286; H01M 8/0273

(57) ABSTRACT

A method of producing a separator for use in a fuel cell includes forming a press joint body including a seal member, a first metal separator, and a second metal separator, and plastically deforming the press joint body by applying a preliminary load to the press joint body in a height direction of the press joint body at a predetermined compression amount. The predetermined compression amount is changed based on a material characteristic of at least one of the seal member, the first metal separator, or the second metal separator.

### CROSS REFERENCE TO RELATED APPLICATIONS

This application claims the foreign priority benefit under 35 U.S.C. § 119 of Japanese patent application No. 2020-197239 filed on Nov. 27 2020, the entire disclosure of which is incorporated herein by reference.

### BACKGROUND OF THE INVENTION

### 1. Field of the Invention

The present invention relates to a method of producing a separator for use in a fuel cell.

### 2. Description of the Related Art

For example, as shown in Japanese Patent No. 6368807 (hereinafter referred to as Patent Literature 1), there is known a fuel cell in which an electrolyte membrane is sandwiched between a pair of joint separators (hereinafter also referred to simply as “separators”) to achieve sealing. Each separator is formed by joining a first metal separator and a second metal separator each including a protruding seal bead portion. A seal member formed of rubber or the like is disposed at the top of the seal bead portion. The seal bead portions of the first and second metal separators form a bead seal portion by facing each other. Sealing can be enhanced by the reaction force of the sealing bead portions and the followability of the seal members.

For example, the bead seal portion according to Patent Literature 1 is greatly affected by an external load and plastically deforms, and for this reason, a preliminary load is applied to the bead seal portion in advance. In a preliminary load applying step, a preliminary load is applied by compressing the separator using a pressure application apparatus.

FIG. 9 is a graph showing the relations between the cell thickness and seal pressure of the fuel cell of Patent Literature 1. A loading characteristic line L4 (the thick broken line) represents the loading characteristics of the separator obtained by application of a preliminary load to the bead seal portion. As apparent from the loading characteristic line L4, plastic deformation does not occur even if there are variations in the load applied to the fuel cell stack, and the loading characteristics can move on the same loading characteristic line L4 between a state where a load is applied and a state where no load is applied.

In addition, if the preliminary load is not applied, the seal bead portion plastically deforms during operation and becomes unable to maintain the seal surface pressure. The preliminary load application also allows mitigation of variations in loading characteristic lines La, Lb, and Lc caused by dimension variations caused by pressing.

However, the loading characteristics change depending on the material characteristics of the seal members, the first metal separator, and the second metal separator that constitute the separator. Examples of the material characteristics include the thickness dimension and hardness of the first and second metal separators and the rubber hardness of the seal members. Thus, there is a problem in that using a constant compression amount for the compression in the preliminary load applying step is not enough to obtain intended loading characteristics (see FIG. 10). The part indicated by the thick lines in the FIG. 10 represents the loading characteristics of a separator obtained by using the same compression amount as that in FIG. 9 to apply a preliminary load to a first metal separator and a second metal separator having material characteristics different from those in FIG. 9. For example, the fastening pressure at a predetermined fastening clearance a in FIG. 10 is higher than a median, which means that an intended fastening pressure cannot be obtained.

It is possible to obtain intended loading characteristics by adjusting (changing) the initial bead heights of the first metal separator and the second metal separator and thereby shifting the loading characteristics (see FIG. 11). However, adjusting the bead heights depending on the material characteristics at the time of press forming requires preparation of a plurality of expensive press molds, and this is a problem because equipment costs increase.

### SUMMARY OF THE INVENTION

The present invention has been invented to solve the above problems and has an object to provide a method of producing a separator with which a separator having desired loading characteristics can be obtained at low costs even if the separator is formed using a material with different material characteristics.

In response to the aforementioned issues, a method of producing a separator for use in a fuel cell includes forming a press joint body including a seal member, a first metal separator, and a second metal separator, and plastically deforming the press joint body by applying a preliminary load to the press joint body in a height direction of the press joint body at a predetermined compression amount. The predetermined compression amount is changed based on a material characteristic of at least one of the seal member, the first metal separator, or the second metal separator.

According to this producing method, a compression amount for the preliminary load application is changed depending on the material characteristics of the seal member, the first metal separator, and the second metal separator that constitute the separator, and thus, a separator having desired loading characteristics can be obtained at low costs.

In some embodiments, the method of producing a separator according to the present invention includes reading a material identification part before the applying of the preliminary load to the press joint body, and the material identification part records the material characteristic of the at least one of the seal member, the first metal separator, or the second metal separator.

According to this producing method, the material characteristics of the seal member, the first metal separator, and the second metal separator can be easily acquired.

In some embodiments, the applying of the preliminary load to the press joint body is performed by using a preliminary load application apparatus, the preliminary load application apparatus includes jigs configured to have respectively clearances during the applying of the preliminary load to the press joint body, and a pressure application part configured to apply the preliminary load to the press joint body via one of the jigs, the clearances have different height dimensions respectively, and the method further includes selecting the one of the jigs based on the material characteristic read from the material identification part before the applying of the preliminary load to the press joint body.

According to this producing method, a jig (compression amount) suitable for the material characteristics of the press joint body can be selected from a plurality of jigs, and thus, the loading characteristics of the separator can be easily adjusted.

In some embodiments, the jigs includes lower jigs respectively, and upper jigs respectively, the clearances are between the lower jigs and the upper jigs respectively, the jigs further include spacers disposed in the clearances respectively, and the spacers have different thickness dimensions respectively.

According to the producing method, the height dimension of the clearance of each jig can be adjusted using spacers, and therefore equipment costs can be reduced.

The separator producing method of the present invention can obtain a separator having desired loading characteristics at low costs even if the separator is formed of a material with different material characteristics.

### BRIEF DESCRIPTION OF THE DRAWINGS

FIG. 1 is a sectional view of a separator according to Example 1.

FIG. 2 is a sectional view of a fuel cell according to Example 1.

FIG. 3 is a sectional view showing a press forming step and an identification information adding step of a method of producing the separator according to Example 1.

FIG. 4 is a sectional view showing a joining step of the method of producing the separator according to Example 1.

FIG. 5 is a sectional view showing a reading step of the method of producing the separator according to Example 1.

FIG. 6 is a schematic diagram showing a jig selecting step and a placing step of the method of producing the separator according to Example 1.

FIG. 7 is a schematic diagram showing a preliminary load applying step of the method of producing the separator according to Example 1.

FIG. 8 is a graph showing the relations between the cell thickness and seal pressure of the separator according to Example 1.

FIG. 9 is a graph showing the relations between the cell thickness and seal pressure of a separator according to Patent Literature 1.

FIG. 10 is a graph showing the relations between the cell thickness and seal pressure of a separator having material characteristics different from that in FIG. 9.

FIG. 11 is a graph showing the relations between the cell thickness and seal pressure of a separator having material characteristics shifted from that in FIG. 9.

### DETAILED DESCRIPTION OF THE EMBODIMENTS

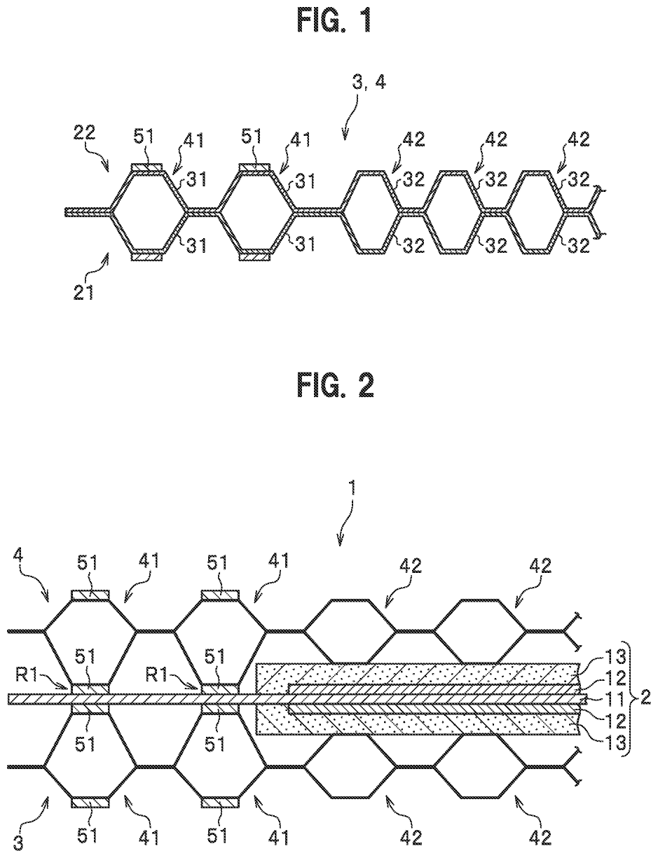

With reference to the drawings, a detailed description is given of a separator producing method and a separator according to an embodiment. As shown in FIG. 1, a first separator 3 (a second separator 4) is a plate-like member for use in a fuel cell, and is formed by a first metal separator 21, a second metal separator 22, and a plurality of seal members 51. A preliminary load is applied to the first separator 3 (the second separator 4) before the first separator 3 is assembled into a fuel cell stack.

In a preliminary load applying step of the separator producing method according to the present embodiment, the amount of compression used in the preliminary load application is changed depending on the material characteristics of at least one of the seal members 51, the first metal separator 21, or the second metal separator 22. Because the compression amount for the preliminary load application is changed depending on the material characteristics of at least one of the seal members 51, the first metal separator 21, or the second metal separator 22, the first separator 3 (the second separator 4) having desired loading characteristics can be obtained at low costs. The following describes an example in detail.

### EXAMPLE 1

A fuel cell stack is obtained by stacking a plurality of fuel cells 1 and applying a predetermined compression load to the stack in a direction in which the fuel cells 1 are stacked. FIG. 2 depicts the fuel cell 1 which has been fastened by application of a predetermined compression load.

An electrolyte membrane electrode assembly (MEA) 2 is configured including an electrolyte membrane 11, electrode catalyst layers 12, 12, and gas diffusion layers 13, 13. The electrolyte membrane 11 projects outward of the gas diffusion layers 13. Note that the portion that projects outward of the gas diffusion layers 13 may be a resin film (resin frame member).

The first separator 3 is a plate-like member disposed at one side (the lower side in FIG. 2) of the electrolyte MEA 2. The second separator 4 is a plate-like member disposed at the other side (the upper side in FIG. 2) of the electrolyte MEA 2. Since the first separator 3 and the second separator 4 have the same configuration in the present example, the same reference numerals as those for the first separator 3 are used for the second separator 4 to omit a detailed description of the second separator 4.

Bead seal portions 41 project toward the electrolyte membrane (or a resin film) and are, for example, formed throughout the outer periphery of the fuel cell 1 to make an endless form. At the top portions of the bead seal portion 41, the seal members 51 are disposed, extending in the direction in which the bead seal portion 41 extends.

The seal members 51 are formed of an elastic material. The seal members 51 of the present example are gaskets which are rectangular in section. The seal members 51 may be formed by, for example, applying a material in a liquid state to the bead seal portions 41 or by attaching a band-shaped material to the bead seal portions 41. Examples of an elastic material usable to form the seal members 51 include ethylene-propylene-diene rubber (EPDM), silicone rubber (VMQ), fluororubber (FKM), polyisobutylene (PIB), SIFEL (registered trademark: Shin-Etsu Chemical Co., Ltd.), and resins, having a rubber hardness of Hs 45 to 55.

A preliminary load is applied to the bead seal portions 41 of the first separator 3 and the second separator 4. A description will be given later regarding the preliminary load.

Next, a description is given of a separator producing method of the present example. Steps performed in the separator producing method of the present example are a press forming step, an identification information adding step, a joining step, a reading step, a jig selecting step, a placing step, and a preliminary load applying step.

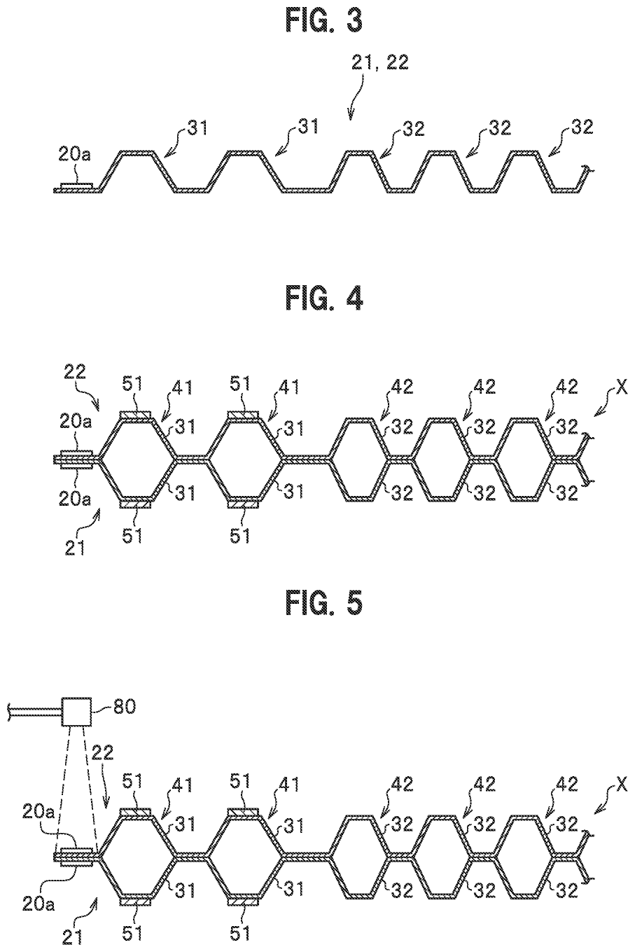

The press forming step is, as shown in FIG. 3, a step of forming the first metal separator 21 and the second metal separator by press forming materials. For example, the first metal separator 21 and the second metal separator 22 are each a metal thin plate having a thickness of approximately 0.03 mm to 0.5 mm and a hardness of Hv 300 or below.

In the present example, materials used for the first metal separator 21 and the second metal separator 22 have the same material characteristics as each other. The first metal separator 21 and the second metal separator 22 formed into shapes each include one or more seal bead portions 31 and one or more protruding portions 32. Note that the numbers, bead heights, and arrangements of the seal bead portions 31 and the protruding portions 32 shown are merely examples, and may be set as appropriate.

The identification information adding step is a step of adding information on the material characteristics of the first metal separator 21 and the second metal separator 22 to the first metal separator 21 and the second metal separator 22. As shown in FIG. 3, in the identification information adding step, a material identification part 20a is provided to a part of each of the first metal separator 21 and the second metal separator 22. For example, a matrix two-dimensional code (QR code (registered trademark: DENSO WAVE INCORPORATION), a one-dimensional code (barcode), or a radio frequency identifier (RFID) can be used as the material identification part 20a. The material identification part 20a contains the material characteristics of at least one of the seal members 51, the first metal separator 21, or the second metal separator 22. Examples of the material characteristics include the rubber hardness of the seal members 51, the thickness dimension and hardness (such as Vickers hardness or Brinell hardness) of the first metal separator 21 and the second metal separator 22. Also, the material identification part 20a may contain identification information pertaining to the producing stage, such as a serial number or a lot number. Note that the identification information adding step may be performed at any time as long as it is before the reading step.

The joining step is, as shown in FIG. 4, a step of joining the first metal separator 21 and the second metal separator 22 to each other and mounting the seal members 51. In the joining step, the first metal separator 21 and the second metal separator 22 are joined to each other at their faces that are opposite from the faces where the seal bead portions 31 project. The first metal separator 21 and the second metal separator 22 are made integral with each other by brazing, swaging, welding, or the like. Then, the seal members 51, 51 are mounted at the top portions of the seal bead portions 31, 31.

After the joining step, the seal bead portions 31, 31 and the seal members 51, 51 form the bead seal portion 41, forming a hollow part within the bead seal portion 41. Also, the protruding portions 32, 32 form a combined protruding portion 42, forming a hollow part within the combined protruding portion 42. Note that a structure formed in the joining step, i.e., a structure constituted by the first metal separator 21, the second metal separator 22, and the plurality of seal members 51 is also referred to as a “press joint body X.”

The reading step is, as shown in FIG. 5, a step of acquiring the material characteristics of the press joint body X. In the reading step, the material identification part 20a is read using a reader 80. Detection data read by the reader 80 is, for example, associated with identification information on the press joint body X (materials constituting the press joint body X), such as a serial number or a lot number, and then transmitted to a control part (not shown) in a pressure application apparatus 70 to be described later.

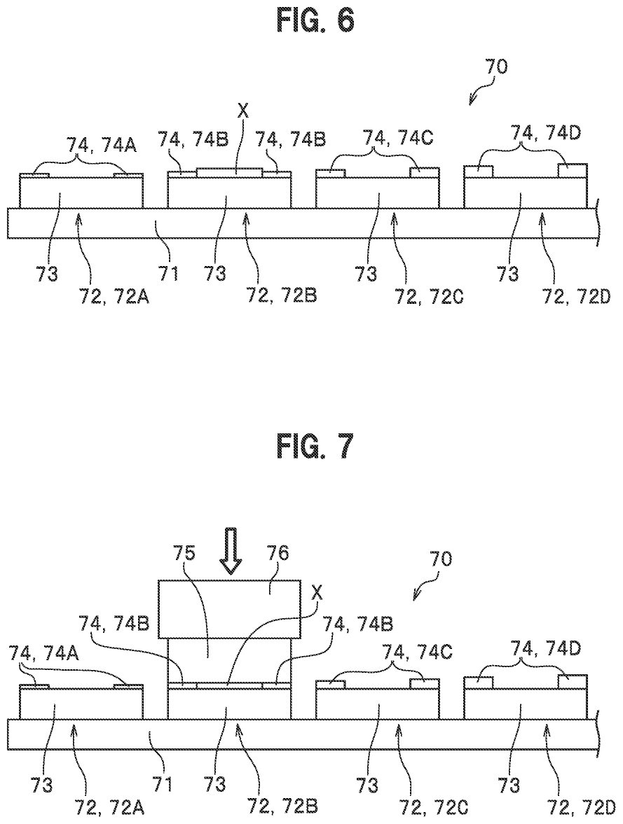

The jig selecting step is, as shown in FIG. 6, a step of selecting one of a plurality of jigs 72 based on the material characteristics read by the reader 80. The pressure application apparatus 70 used in the preliminary load applying step is now described. As shown in FIGS. 6 and 7, the pressure application apparatus 70 is an apparatus for applying a preliminary load to the press joint body X. The pressure application apparatus 70 includes a base 71, a plurality of jigs 72, a pressure application part 76, a control device (not shown), and a transporter (not shown).

The plurality of jigs 72 are arranged side by side on the plate-like base 71 with spaces interposed therebetween. As an example, four jigs 72 (jigs 72A, 72B, 72C, 72D) are provided in the present example. Each jig 72 is formed by a lower jig 73, an upper jig 75, and a pair of spacers 74 disposed between the lower jig 73 and the upper jig 75. The lower jig 73 is a member on which the press joint body X is to be placed, and the lower jigs 73 of all the jigs 72 have the same height dimension. The upper jig 75 is a member to be disposed between the press joint body X and the pressure application part 76. The spacers 74 are set so that their thickness dimensions gradually increase in the order of the spacers 74A, 74B, 74C, and 74D. In other words, the height dimensions of the spaces between the lower jigs 73 and the upper jigs 75 for the preliminary load application are set in such manner as to increase in the order of the jigs 72A, 72B, 72C, and 72D.

The pressure application part 76 is, as shown in FIG. 7, a part for pressing the upper jig 75 (the press joint body X) and is configured to lower until the upper jig 75 comes into contact with the spacers 74. Thus, if the jig 72A having the spacers 74 with the smallest height dimension of all the jigs 72 is used, the largest amount of compression is exerted to the press joint body X (i.e., the preliminary load is largest), and if the jig 72D having the spacers 74 with the largest height dimension of all the jigs 72 is used, the smallest amount of compression is exerted to the press joint body X (i.e., the preliminary load is smallest).

The control device (not shown) is a device that performs overall control of the pressure application apparatus 70. The control device is configured including a control part, an input part, a display part, a storage part, and the like. The control part includes a “jig selector” that selects the jig 72 to which the press joint body X corresponds, based on the detection data transmitted from the reader 80.

The storage part is formed by a storage medium such as a random-access memory (RAM), a read-only memory (ROM), a hard disk drive (HDD), or a flash memory. A selection result obtained by the jig selector is stored in the storage part in a manner associated with the press joint body X. The storage part also has stored therein, e.g., a jig selection data file used as the criteria for selecting the jig 72.

The jig selection data file is a file defining, for example, which of the jigs 72 detection data transmitted from the reader 80 corresponds to. Compression restoring property differs depending on the thickness dimension and hardness of the first metal separator and the second metal separator 22 and the hardness (rubber hardness) of the seal members 51. Thus, the jig selection data file has stored therein the relations between these thickness dimensions and hardnesses and appropriate compression amounts (the height dimensions between the lower jig 73 and the upper jig 75) for the preliminary load application. The jig selection data file is generated as appropriate based on the thickness dimensions and hardnesses of a plurality of materials and the compression restoring properties of those materials, all of these pieces of information being obtained in advance.

In the present example, the jig selection data file sets definitions by providing thresholds for the thickness dimensions and hardnesses. Definitions are set as follows. The jig 72A is selected if the thickness dimension and the hardness are both above their thresholds, the jig 72B is selected if the thickness dimension is equal to or above the threshold and the hardness is below the threshold, the jig 72C is selected if the thickness dimension is below the threshold and the hardness is equal to or above the threshold, and the jig 72D is selected if the thickness dimension and the hardness are both below their thresholds. Note that the jig selection data file may be set as appropriate according to the kinds of the materials and the performance required of the separator.

The transporter is a device that transports, to the jig 72 selected by the jig selector of the control part, the press joint body X corresponding to that selection result, and places the press joint body X onto the lower jig 73. For example, a transport robot can be used as the transporter.

In the jig selecting step, the jig selector of the control part selects, based on the jig selection data file, the jig 72 that is suitable for the detection data transmitted from the reader 80.

The placing step is, as shown in FIG. 6, a step of placing the press joint body X onto the jig 72 (the jig 72B here) selected in the jig selecting step. The transporter transports the press joint body X to the selected jig 72 based on a transport signal transmitted from the control part.

The preliminary load applying step is, as shown in FIG. 7, a step of applying a preliminary load to the press joint body X by compression. In the preliminary load applying step, based on a preliminary load application signal transmitted from the control part, the pressure application part 76 is lowered until the upper jig 75 comes into contact with the spacers 74B, 74B, thereby compressing and thus applying a preliminary load to the press joint body X. As a result of the above steps, the first separator 3 (the second separator 4) is formed.

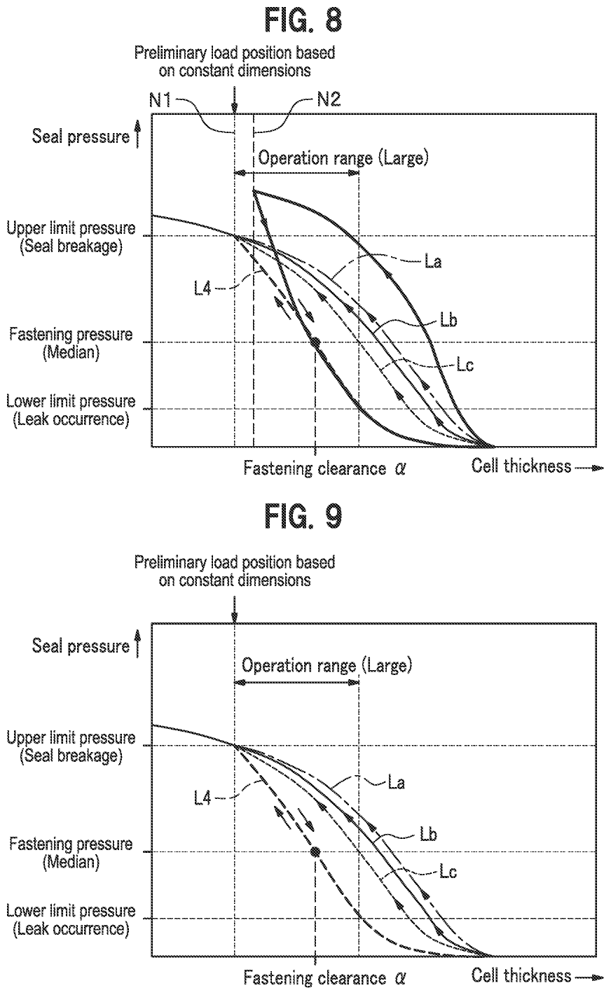

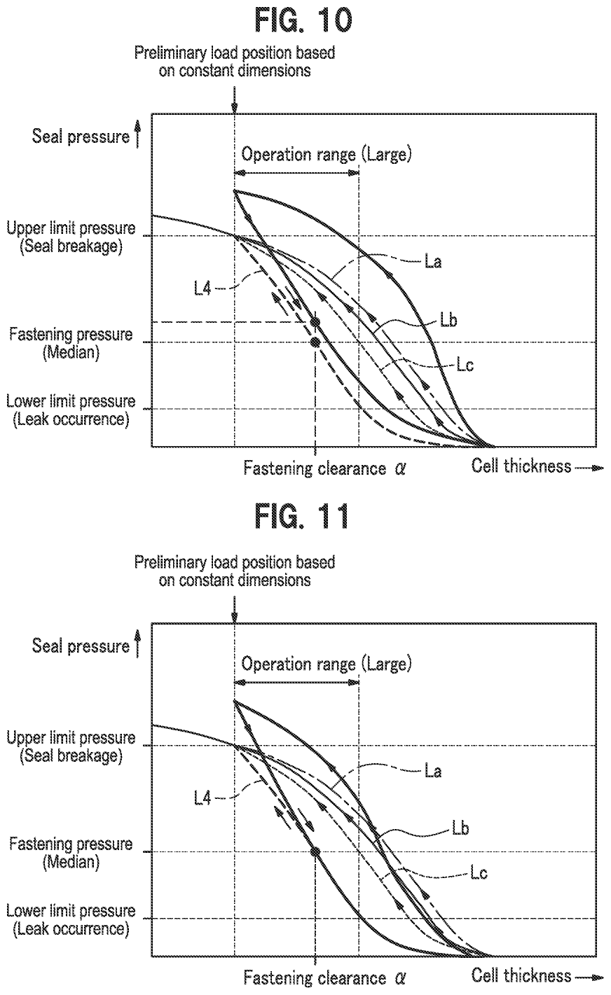

FIG. 8 is a graph showing the relation between the cell thickness and the seal pressure of the separator according to Example 1. The thick lines shown in FIG. 8 are lines representing the loading characteristics of the first separator 3 (the second separator 4) formed in the present example. As shown in FIG. 8, conventionally, the position (the compression amount) for the preliminary load application is at a preliminary load position N1 based on constant dimensions. By contrast, in the present example, the preliminary load position is adjusted to a preliminary load position N2 according to the material characteristics. Thus, even in a case of a material with different material characteristics, the fastening pressure for a fastening clearance a can be set at a median of the fastening pressure. In other words, in the present example, even in a case of a material with different material characteristics, the fastening pressure for a fastening clearance a can be set at a median of the fastening pressure, and thus a separator having desired loading characteristics can be obtained.

According to the present example thus described, the compression amount for the preliminary load application is changed depending on the material characteristics of at least one of the seal members 51, the first metal separator 21, or the second metal separator 22, and therefore the first separator 3 (the second separator 4) having desired loading characteristics can be obtained at low costs.

Also, by including the step of reading the material identification part 20a before the preliminary load applying step, the separator producing method can easily acquire the material characteristics of at least one of the seal members 51, the first metal separator 21, or the second metal separator 22.

Also, before performing the preliminary load applying step, the present example performs the jig selecting step of selecting one of the plurality of jigs 72 based on the material characteristics read in the reading step. This allows the jig 72 (the compression amount) suitable for the material characteristics of the press joint body X to be selected, which facilitates adjustment of the loading characteristics of the first separator 3 (the second separator 4).

Also, in the press forming step, there is no need to change the height dimension of the seal bead portion 31 according to the material characteristics, which enables elimination of the need to prepare a plurality of kinds of press molds and therefore a reduction in equipment costs. Also, in the preliminary load applying step, the compression amount of each jig 72 (the height dimension of the clearance between the lower jig 73 and the upper jig 75) can be changed easily at low costs merely by the placement of the spacers 74 with different thicknesses (74A, 74B, 74C, 74D) on the lower jigs 73. Also, since the pressure application part 76 only has to be lowered until the upper jig 75 comes into contact with the spacers 74, the work for setting the pressure application apparatus 70 can be easily done.

Also, in the jig selecting step, based on the detection data transmitted from the reader 80 and the preset jig selection data file, the jig 72 suitable for the material characteristics of the material(s) can be easily selected from the jigs 72 with different clearance height dimensions.

It is understood that the foregoing description is that of the preferred embodiments of the invention and that various changes and modifications may be made thereto without departing from the spirit and scope of the invention as defined in the appended claims. For example, the reading step may be performed at any time as long as it is before the preliminary load applying step. Also, although the compression amount (the height dimension of the clearance between the lower jig 73 and the upper jig 75) is adjusted using the spacers 74 in the present example, a different method may be used for the adjustment. For example, the compression amount may be adjusted by changing the distance by which the pressure application part 76 is lowered, with the height dimensions of each lower jig 73 and each upper jig 75 being constant. Also, the material characteristics of materials (the seal members 51, the first metal separator 21, and the second metal separator 22) may include not only the thickness dimension and hardness, but also other elements.

What is claimed is:

1. A method of producing a separator for use in a fuel cell, the method comprising:
forming a press joint body comprising:
a seal member;
a first metal separator; and
a second metal separator; and
plastically deforming the press joint body by applying a preliminary load to the press joint body in a height direction of the press joint body at a predetermined compression amount, and
wherein the predetermined compression amount is changed based on a material characteristic of at least one of the seal member, the first metal separator, or the second metal separator.

2. The method according to claim 1, further comprising:
reading a material identification part before the applying of the preliminary load to the press joint body,
wherein the material identification part records the material characteristic of the at least one of the seal member, the first metal separator, or the second metal separator.

3. The method according to claim 2, wherein the applying of the preliminary load to the press joint body is performed by using a preliminary load application apparatus,
wherein the preliminary load application apparatus comprises:
jigs configured to have respectively clearances during the applying of the preliminary load to the press joint body; and
a pressure application part configured to apply the preliminary load to the press joint body via one of the jigs,
wherein the clearances have different height dimensions respectively, and
wherein the method further comprises selecting the one of the jigs based on the material characteristic read from the material identification part before the applying of the preliminary load to the press joint body.

4. The method according to claim 3, wherein the jigs comprise:
lower jigs respectively; and
upper jigs respectively,
wherein the clearances are between the lower jigs and the upper jigs respectively,
wherein the jigs further comprise spacers disposed in the clearances respectively, and
wherein the spacers have different thickness dimensions respectively.
